(19) United States
(12) Patent Application Publication
(10) Pub. No.: US 2024/0320061 A1
(43) Pub. Date: Sep. 26, 2024

(54) METHOD AND SYSTEM FOR CONTROLLING ACCESS TO SHARED RESOURCES

(71) Applicant: SAMSUNG ELECTRONICS CO., LTD., Suwon-si (KR)

(72) Inventors: Bumgyu PARK, Suwon-si (KR); Jonglae Park, Suwon-si (KR); Sangkyu Kim, Suwon-si (KR); Eunok Jo, Suwon-si (KR)

(73) Assignee: SAMSUNG ELECTRONICS CO., LTD., Suwon-si (KR)

(21) Appl. No.: 18/528,160

(22) Filed: Dec. 4, 2023

(30) Foreign Application Priority Data
Mar. 24, 2023 (KR) 10-2023-0039007
Apr. 11, 2023 (KR) 10-2023-0047582

(51) Int. Cl. G06F 9/52

(52) U.S. Cl. CPC G06F 9/526

(57) ABSTRACT

Provided is a method of controlling access a shared resources when executing a first process that acquires a lock on the shared resource and adding a second process to a waiting queue. A determination is made on whether to deactivate preemption for the processor based on a priority of the second process, and based on determining to deactivate preemption for the processor, executing the first process until execution of the first process on the shared resource is completed, then retrieving the lock from the first process after execution of the first process on the shared resource is completed and reactivating preemption for the processor.

### CROSS-REFERENCE TO RELATED APPLICATION(S)

This application is based on and claims priority under 35 U.S.C. § 119 to Korean Patent Application No. 10-2023-0039007, filed on Mar. 24, 2023, and Korean Patent Application No. 10-2023-0047582, filed on Apr. 11, 2023, in the Korean Intellectual Property Office, the disclosures of which are incorporated by reference herein in their entireties.

### BACKGROUND

### 1. Field

The disclosure relates to a method and a system for controlling access to shared resources, and more specifically, reducing lock contention between processes by controlling a lock release time point of a lock owning process.

### 2. Description of Related Art

An operating system (OS) may be software that manages computer hardware. The OS may provide a basis for various application programs and may intermediate between a computer user and computer hardware. A computer system may have a number of processes loaded into memory, and execute one or more of the processes to perform operation(s). For example, the computer system can execute multiple processes and manage access to shared resources for the processes by granting/retrieving locks on the shared resources.

In a software structure in which multiple processes simultaneously access shared resources set as critical sections, if the lock owning process for accessing the critical sections releases the lock late, contention between processes waiting to access the shared resources may be intensified. Due to the contention between processes, a waiting time until a process is executed may be prolonged and priority inversion may occur. Furthermore, in heterogeneous multi-core processor environments or distributed systems, performance inversion may occur. Due to these problems, performance of the computer system may become degraded, and in severe cases, fatal system faults may occur.

### SUMMARY

Provided are a method and a system for controlling a time point at which a process that owns a lock (a lock owning process) on a system resource releases the lock. For example, a time point at which a lock owning process releases its lock may be controlled to prevent the lock owning process from being blocked by other processes.

According to an aspect of an embodiment, a method of controlling access to shared resources, includes: executing, by a processor, a first process that acquires a lock on a shared resource; adding a second process to a waiting queue; determining whether to deactivate preemption for the processor based on a priority of the second process; based on determining to deactivate preemption for the processor, executing, by the processor, the first process until execution of the first process on the shared resource is completed; retrieving the lock from the first process after execution of the first process on the shared resource is completed; and reactivating preemption for the processor.

According to an aspect of an embodiment, a method of controlling access to shared resources, includes: executing, by a processor operating in a first mode, a first process that acquires a lock on a shared resource; adding a second process to a waiting queue; controlling the processor to operate in a second mode based on a priority of the second process; executing the first process, by the processor operating in the second mode, until execution of the first process on the shared resource is completed; retrieving the lock from the first process after execution of the first process on the shared resource is completed; and controlling the processor to operate in the first mode.

According to an aspect of an embodiment, a method of controlling access to shared resources, includes: executing, by a processor, a read operation of a first process that acquires a lock on a shared resource during a read phase, the read operation corresponding to the shared resource; adding a write operation of a second process and a read operation of a third process to a waiting queue, the write operation of the second process and the read operation of the third process corresponding to the shared resource; determining whether to extend the read phase based on a priority of the third process and a priority of the second process; based on determining to extend the read phase, executing, by the processor, the read operation of the third process; and terminating the read phase.

According to an aspect of an embodiment, a system includes: a memory storing a shared resource, a waiting queue, and at least one instruction; and at least one processor configured to execute the at least one instruction to: execute a first process that acquires a lock on the shared resource; add a second process to the waiting queue; determine whether to deactivate preemption for the processor based on a priority of the second process; based on determining to deactivate preemption for the processor, execute the first process until execution of the first process on the shared resource is completed; retrieve the lock from the first process after execution of the first process on the shared resource is completed; and reactivate preemption for the processor.

According to an aspect of an embodiment, a system includes: a memory storing a shared resource, a waiting queue, and at least one instruction; and at least one processor configured to operate in at least a first mode or a second mode, and execute the at least one instruction to: while the at least one processor is operating in the first mode, execute a first process that acquires a lock on the shared resource; add a second process to the waiting queue; control the at least one processor to operate in the second mode based on a priority of the second process; while the at least one processor is operating in the second mode, execute the first process until execution of the first process on the shared resource is completed; retrieve the lock from the first process after execution of the first process on the shared resource is completed; and control the at least one processor to operate in the first mode.

According to an aspect of an embodiment, a system includes: a memory storing a shared resource, a waiting queue, and at least one instruction; and at least one processor configured to operate in at least a first mode or a second mode, and execute the at least one instruction to: execute a read operation of a first process that acquires a lock on the shared resource during a read phase, the read operation corresponding to the shared resource; add a write operation of a second process and a read operation of a third process to the waiting queue, the write operation of the second process and the read operation of the third process corresponding to the shared resource; determine whether to extend the read phase based on a priority of the third process and a priority of the second process; based on determining to extend the read phase, execute the read operation of the third process; and terminate the read phase.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a system according to one or more embodiments;

FIG. 2 is a block diagram of a system according to one or more embodiments;

FIG. 3 is a diagram illustrating a lock release time point of a process in a system according to one or more embodiments;

FIG. 4 is a flow chart illustrating a method of operating a system, according to one or more embodiments;

FIG. 5 is a block diagram of a system according to one or more embodiments;

FIG. 6 is a diagram illustrating a lock release time point of a process in a system according to one or more embodiments;

FIG. 7 is a block diagram of a system according to one or more embodiments;

FIG. 8 is a diagram illustrating a lock release time point of a process in a system according to one or more embodiments;

FIG. 9 is a flowchart illustrating a method of operating a system, according to one or more embodiments;

FIG. 10 is a block diagram of a system according to one or more embodiments;

FIG. 11 is a diagram illustrating a lock release time point of a process in a system according to one or more embodiments;

FIG. 12 is a flowchart illustrating a method of operating a system, according to one or more embodiments; and

FIG. 13 is a block diagram of a system according to one or more embodiments.

### DETAILED DESCRIPTION

Hereinafter, embodiments of the present disclosure will be described in detail with reference to the accompanying drawings, where similar reference characters denote corresponding features consistently throughout, and duplicate descriptions thereof are omitted.

The embodiments disclosed in the specification and drawings are only intended to provide specific examples for easily describing the technical content of the disclosure and for assisting understanding of the disclosure, and are not intended to limit the scope of the disclosure. It will be understood by those of ordinary skill in the art that the present disclosure may be easily modified into other detailed forms without changing the technical principle or essential features of the present disclosure, and without departing from the gist of the disclosure as claimed by the appended claims and their equivalents. Therefore, it should be interpreted that the scope of the disclosure includes all changes or modifications derived based on the technical idea of the disclosure in addition to the embodiments disclosed herein. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

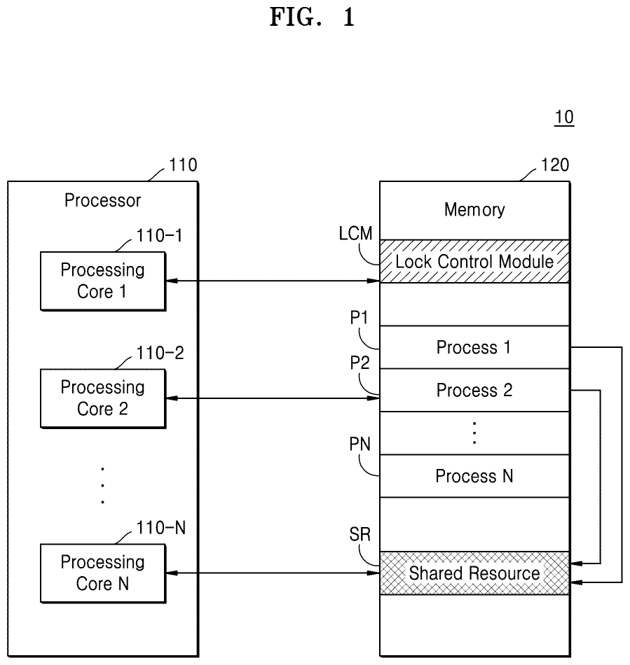

FIG. 1 is a block diagram of a system 10 according to one or more embodiments.

Referring to FIG. 1, the system 10 may refer to any system that includes a processor 110 and memory 120. In an embodiment, the processor 110 may include a plurality of processing cores, such as, for example, a first processing core 110-1, a second processing core 110-2, . . . , and an Nth processing core 110-N (e.g., Processing Core 1, Processing Core 2, . . . , Processing Core N). For example, the system 10 may be a computing system, such as a personal computer, a mobile phone, a server, and the like, a module in which the plurality of processing cores 110-1 to 110-N and the memory 120 are mounted to a substrate as independent packages, and a system-on-chip (SoC) in which the plurality of processing cores 110-1 to 110-N and the memory 120 are embedded in one chip. As shown in FIG. 1, the system 10 may include the plurality of processing cores 110-1 to 110-N, where N is an integer greater than 1, and the memory 120. The first to Nth processing cores 110-1 to 110-N may be collectively referred to as a multi-core processor (e.g., processor 110), and the system 10 that includes the first to Nth processing cores 110-1 to 110-N and the memory 120 may be referred to as a multi-core processor.

The plurality of processing cores 110-1 to 110-N may communicate with the memory 120 and may independently execute instructions. In an embodiment, each of the plurality of processing cores 110-1 to 110-N may execute a process assigned thereto from among a plurality of processes included in the memory 120, such as, for example, a first process P1, a second process P2, . . . , an Nth process PN (e.g., Process 1, Process 2, . . . , Process N). For example, the first processing core 110-1 may execute the second process P2 included in the memory 120.

Each process may include a series of instructions. Each process may include at least one thread. The thread may refer to a unit of a job assigned to the plurality of processing cores 110-1 to 110-N by a scheduler of an operating system (OS). In an embodiment, the process may be a single thread process or a multi-thread process. Hereinafter, for convenience of description, the process is a single thread process. However, according to one or more embodiments, a method of granting a lock to a process and retrieving the lock may be applied not only to a single thread process but also to a multi-thread process.

Hereinafter, when the process performs an operation, it may mean that a series of instructions included in the process are executed by a processor 110. Similarly, when the process performs an operation on a shared resource SR, it may mean that a series of instructions related to data of the shared resource SR are executed by the processor 110. Herein, when the execution of the process is completed, it may mean that the process completes performing an operation on the shared resource. Thus, when the process completes execution, the process may release a lock that the process owned.

The processing core may be any hardware capable of independently executing instructions and may be referred to as a central processing unit (CPU), a processor core, a core, and the like. In an embodiment, the plurality of processing cores 110-1 to 110-N may be homogeneous processing cores. For example, each of the plurality of processing cores 110-1 to 110-N may provide the same performance (e.g., execution time, and power consumption) when executing the same task.

In an embodiment, the plurality of processing cores 110-1 to 110-N may be heterogeneous processing cores. For example, the processor 110 may be a processor designed according to the ARM big.LITTLE heterogeneous processing architecture. The plurality of processing cores 110-1 to 110-N may include processing cores that provide relatively high performance and power consumption (which may be referred to herein as big cores) and processing cores that provide relatively low performance and power consumption (which may be referred to herein as little cores). Accordingly, each of the heterogeneous processing cores may provide different performances (e.g., execution time, and power consumption) when executing the same task.

The memory 120 may be accessed by the plurality of processing cores 110-1 to 110-N and may store a software element executable by the plurality of processing cores 110-1 to 110-N. For example, as shown in FIG. 1, the memory 120 may store a lock control module LCM, and the processes P1 to PN may be located in the memory 120. The software element may include, but is not limited to, a software component, a program, an application, a computer program, an application program, a system program, a software development program, a machine program, OS software, middleware, firmware, a software module, a routine, a subroutine, a function, a method, a procedure, a software interface, an application program interface (API), an instruction set, computing code, computer code, a code segment, a computer code segment, a word, a value, a symbol, or a combination of two or more thereof.

The memory 120 may be any hardware capable of storing information and accessible by the plurality of processing cores 110-1 to 110-N. For example, the memory 120 may include read only memory (ROM), random-access memory (RAM), dynamic random access memory (DRAM), double-data-rate dynamic random access memory (DDR-DRAM), synchronous dynamic random access memory (SDRAM), static random access memory (SRAM), magnetoresistive random access memory (MRAM), programmable read only memory (PROM), erasable programmable read-only memory (EPROM), electrically erasable programmable read only memory (EEPROM), flash memory, polymer memory, phase change memory, ferroelectric memory, silicon-oxide-nitride-oxide-silicon (SONOS) memory, magnetic cards/disks, optical cards/disks, or a combination of two or more thereof.

When the processor 110 executes the plurality of processes P1 to PN, the processor 110 may require access to data of a shared resource SR in the memory 120. In an embodiment, the first process P1 and the second process P2 may share the shared resource SR. That is, in order for the processor 110 to execute the first process P1 and the second process P2, access to data of the shared resource SR may be required.

When there are two or more processes that require access to data of the shared resource SR, a synchronization tool may be needed to synchronize the shared resource SR. In this case, the data of the shared resource SR may refer to a critical section. The synchronization tool may be provided by the OS, and the synchronization tool may include, e.g., lock, semaphore, binary semaphore, counting semaphore, mutex, or monitor. Herein, these synchronization tools are referred to as locks. To prevent multiple processes from accessing the shared resource SR simultaneously and modifying data of the shared resource SR, the OS may grant the lock to the process through the lock control module LCM. Hereinafter, the process that acquired the lock may be referred to as a lock owning process.

In an embodiment, the lock may be first granted to a process executed by the processor 110. For example, when the first process P1 acquired the lock to access the shared resource SR, the second process P2 may wait in a waiting queue included in the lock control module LCM without being executed until the first process P1 releases the lock.

In an embodiment, the lock may include a read lock and a write lock. When multiple processes perform a read operation on the shared resource SR, the read lock may be assigned to the multiple processes performing the read operation. When multiple processes perform a write operation on the shared resource SR, the write lock may be granted only to one process performing the write operation.

For example, the first process P1 and the second process P2 require access to the shared resource SR for the read operation. When the first process P1 is executed by the first processing core 110-1, the first process P1 may acquire the read lock. Although the first process P1 does not release the read lock, the second process P2 may acquire the read lock, and the second process P2 may be executed by the second processing core 110-2. Thus, the first process P1 and the second process P2 may perform the read operation on the shared resource SR.

For example, the first process P1 and the second process P2 require access to the shared resource SR for the write operation. When the first process P1 is executed by the first processing core 110-1, the first process P1 may acquire the write lock. The second process P2 may not be executed until the first process P1 releases the write lock.

The lock control module LCM may be executed by at least one of the plurality of processing cores 110-1 to 110-N. Herein, when the processing core executes the lock control module LCM to perform an operation, it may be simply expressed as the lock control module LCM performing an operation. The lock control module LCM may perform a series of operations to grant a lock to processes and retrieve the lock from the processes. The lock control module LCM may perform an operation of changing an operation mode of the processor 110. The lock control module LCM may schedule processes to be executed by the processor 110. In an embodiment, the lock control module LCM may be included in a kernel. For example, the OS may be executed in the system 10, and applications may be executed on the OS. The lock control module LCM may control access to the shared resource SR by processes generated in higher layers (e.g., frameworks and applications) and/or processes generated in the kernel including the lock control module LCM.

The lock control module LCM may control the lock release time point of the lock owning process. In an embodiment, the lock control module LCM may control the release of the lock of the lock owning process by deactivating preemption for the processor 110 while the processor 110 is executing the lock owning process.

In an embodiment, the lock control module LCM may control the release of the lock of the lock owning process by changing an operation mode of the processor 110 from a first mode to a second mode when the processor 110 is executing the lock owning process.

In an embodiment, the lock control module LCM may control the release of the lock of the lock owning process by extending a read phase when the processor 110 is executing the read operation of the lock owning process.

In an embodiment, the lock control module LCM may be stored in a computer-readable non-transitory storage medium. The term “computer-readable storage medium” may include any type of medium that may be accessed by a computer, such as ROM, RAM, a hard disk drive, a compact disk (CD), a digital video disk (DVD), or any other type of memory. The “non-transitory” computer-readable storage medium may include a medium for storing data permanently, and a medium for storing and overwriting data, such as a rewritable optical disk or an erasable memory device, excluding wired, wireless, optical, or other communication links that transmit transitory electrical or other signals.

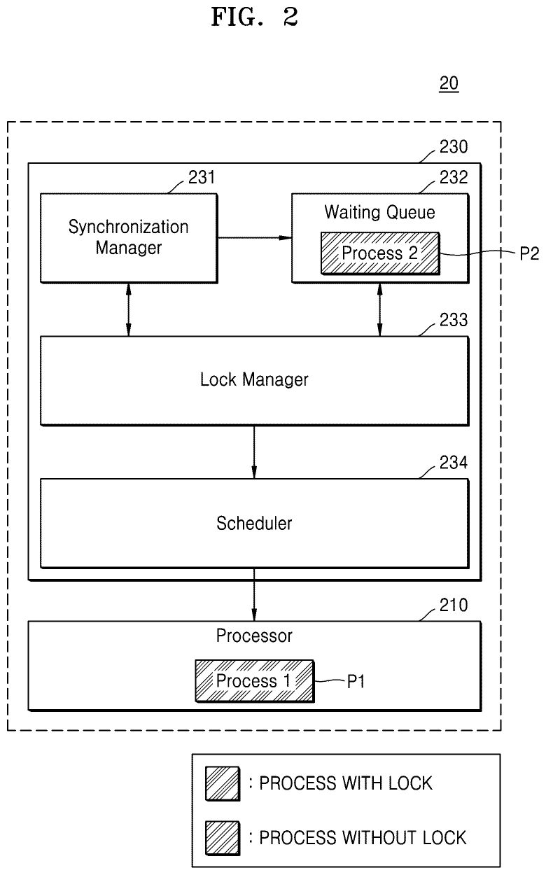

FIG. 2 is a block diagram of a system 20 according to one or more embodiments. Specifically, FIG. 2 is a diagram illustrating controlling the release of the lock of the lock owning process by deactivating preemption for the processor 210. FIG. 2 may be described with reference to FIG. 1, and duplicate descriptions may be omitted. In FIG. 2, the first process P1 and the second process P2 are processes including instructions for accessing the shared resource SR and processing information while being executed by the processor 210.

Referring to FIG. 2, the system 20 may include a processor 210 and a lock control module 230. The system 20 may correspond to the system 10 of FIG. 1. The system 20 of FIG. 2 may further include memory. The processor 210 may correspond to the processor 110 of FIG. 1.

The lock control module 230 may include a synchronization manager 231, a waiting queue 232, a lock manager 233, and a scheduler 234. In an embodiment, elements constituting the lock control module 230 may be implemented in software or hardware. The lock control module 230 may correspond to the lock control module LCM of FIG. 1.

The synchronization manager 231 may manage the shared resource SR to be synchronized when there are two or more processes that need to perform an operation on the shared resource SR. The synchronization manager 231 may detect whether the processes operate on the shared resource SR. The synchronization manager 231 may grant a lock to processes performing an operation on the shared resource SR and retrieve the lock. The synchronization manager 231 may add a process that has not acquired the lock to the waiting queue 232. When the synchronization manager 231 retrieves the lock from the lock owning process, it may transfer information indicating that the process has released the lock to the lock manager 233. The synchronization manager 231 may retrieve the lock from the process and then grant the lock to the process waiting in the waiting queue 232, thereby causing the waiting process to be executed by the processor 210.

In an embodiment, the synchronization manager 231 may grant the lock to the first process P1 when access to the shared resource SR is required for the first process P1 to perform an operation. In other words, the first process P1 may acquire the lock on the shared resource SR from the synchronization manager 231. The synchronization manager 231 may retrieve the lock on the shared resource SR from the first process P1 when the first process P1 completes the operation on the shared resource SR. In other words, the first process P1 may release the lock to the synchronization manager 231.

In an embodiment, when the first process P1 that owns the lock on the shared resource SR is executed by the processor 210 and the second process P2 also needs to perform an operation on the shared resource SR, the synchronization manager 231 may add the second process P2 to the waiting queue 232. When the first process P1 releases the lock, the synchronization manager 231 may control the waiting queue 232 to dequeue the second process P2 from the waiting queue 232, thereby causing the second process P2 to be executed by the processor 210.

The waiting queue 232 may be a queue configured to cause processes that have not acquired the lock on the shared resource SR to wait due to a process that first acquired the lock on the shared resource SR. In an embodiment, when the first process P1 that owns the lock on the shared resource SR is executed by the processor 210, the second process P2 may wait in the waiting queue 232 until the first process P1 releases the lock.

When a new process is added to the waiting queue 232, the lock manager 233 may determine to deactivate preemption for the processor 210 based on the priority of the added process. The lock manager 233 may determine to activate preemption for the processor 210 when the execution of the lock owning process on the shared resource SR is completed.

The priority of a process may refer to a priority to be executed by the processor 210. Hereinafter, a process with high priority may refer to a process with high importance, and unless a relative priority comparison is performed with other processes, a process with high priority or a process with high importance may refer to a process with high absolute priority on the system 10.

In an embodiment, the process with high importance may refer to a process with high contribution to the performance of the system 20. For example, the OS may group processes into a top-app group, a background group or a foreground group, according to their importance, and the processes with high contribution to the performance of the system 20 may be grouped into the top-app group.

In an embodiment, the process with high importance may be a latency-sensitive process. Hereinafter, the latency-sensitive process may be referred to as a process with high latency sensitivity. For example, a Linux kernel may classify the processes into a real time process and a normal process, where the real time process may be more important than the normal process.

In an embodiment, the process with high importance may refer to a process designed to have high priority according to a developer's intent. These processes may include priority information when generated (i.e., when data associated with the process is loaded into memory by executing the process), which may be designed to have a value greater than a preset reference value. For example, the processes with normal priority may have a priority reference value. The priority reference value may be a preset value basically granted to a process that does not require a particularly high priority in the OS. On the other hand, the processes with high priority may have higher priority information than a reference value. When the second process P2 has priority information greater than the reference value, the second process P2 may be a process with high importance.

Herein, the preemption may refer to preemptive scheduling by the scheduler 234. When the preemption is activated, it may mean that the preemptive scheduling is activated. For example, the lock owning process is being executed by the processor 210 with the preemption for the processor 210 activated, and the process requiring the lock with high priority is waiting in the waiting queue 232. When the preemption is activated, context switching may occur so that the processor 210 executes the process with high priority according to the preemptive scheduling of the scheduler 234 even before the processor 210 causes the process that acquired the lock to release the lock. However, although the process that has not acquired the lock is executed by the processor 210, the operation may not be completed because the process cannot access the shared resource SR. Due to such unnecessary context switching, the time point at which the lock owning process releases the lock may be delayed and the overall operation of the system 20 may be slowed down. Thus, in order for the system 10 to quickly process information by executing the lock owning process and processes that do not own a lock, it may be necessary to make the lock owning process release the lock by executing the lock owning process first to complete the operation on the shared resource SR even when the process with high priority is waiting in the waiting queue.

For example, when the preemption is deactivated, it may mean that the preemptive scheduling is deactivated. While the preemption is deactivated and the process with high priority is waiting in the waiting queue 232, the processes waiting in the waiting queue 232 may be executed by the processor 210 only when the lock owning process releases the lock. This may prevent the lock owning process from being blocked by other processes with high priority, thereby advancing the time point at which the process that acquired the lock releases the lock.

The scheduler 234 may determine a process to be executed by the processor 210 and may assign the determined process to the processor 210. In addition, the scheduler 234 may operate under the control by the lock manager 233 to assign processes to the processor 210 based on the priority of the processes. The scheduler 234 may allocate a processing core to a process selected from the processes waiting in the waiting queue 232.

In an embodiment, the lock manager 233 may determine to deactivate preemptive scheduling through the scheduler 234. When the preemptive scheduling is deactivated, the scheduler 234 may schedule an order of execution between processes such that context switching does not occur to the processes waiting in the waiting queue 232 until the lock owning process releases the lock to the processor 210.

In an embodiment, the lock manager 233 may determine to activate the preemptive scheduling through the scheduler 234. When the preemptive scheduling is activated, the scheduler 234 may schedule an order of execution between processes so that context switching to another process waiting in the waiting queue 232 occurs although the lock is not released to the lock owning process by the processor 210. In an embodiment, when the lock manager 233 checks the priority of the second process P2 and determines that the priority of the second process P2 is high priority, the lock manager 233 may determine to activate the preemption for the processor 210.

In an embodiment, the processor 210 may execute the first process P1 and the second process P2. The first process P1 may be a process that acquired the lock required to access the shared resource SR. The second process P2 may be a process that has not acquired the lock because the first process P1 acquired the lock first although the second process P2 also needs to access the shared resource SR to perform an operation. The processor 210 may execute the first process P1 that acquired the lock. While the processor 210 is executing the first process P1, the kernel may request that the second process P2 be executed. The synchronization manager 231 may add the second process P2 to the waiting queue 232. The lock manager 233 may check the priority of the second process P2. When the priority of the second process P2 is determined to be high priority, the lock manager 233 may determine to deactivate the preemption for the processor 210, and may control the scheduler 234 to deactivate the preemptive scheduling. The processor 210 may continue to execute the first process P1. After the execution of the first process P1 on the shared resource SR is completed, the first process P1 may release the lock to the synchronization manager 231. That is, the synchronization manager 231 may retrieve the lock from the first process P1. When the first process P1 releases the lock to the synchronization manager 231, the synchronization manager 231 may transmit information to the lock manager 233 that the lock has been released. The lock manager 233 may control the scheduler 234 to reactivate the preemptive scheduling, according to the information that the lock has been released transmitted by the synchronization manager 231. The preemption for the processor 210 may be reactivated in response to the release of the lock by the first process P1. After the preemptive scheduling is reactivated, the second process P2 may acquire the lock from the synchronization manager 231 and may be executed by the processor 210.

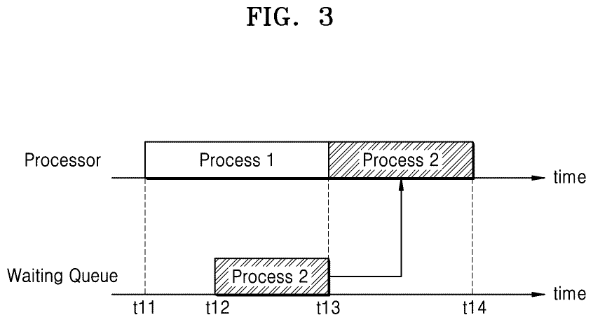

FIG. 3 is a diagram illustrating a lock release time point of a process in a system 20 according to one or more embodiments. FIG. 3 may be described with reference to FIGS. 1 and 2, and duplicate descriptions may be omitted. In FIG. 3, the first process P1 and the second process P2 are processes including instructions for accessing the shared resource SR and processing information while being executed by the processor 210.

Referring to FIG. 3, the scheduler 234 may schedule processes by not performing preemptive scheduling. That is, the preemption for the processor 210 may be deactivated.

In an embodiment, the second process P2 is a process with high priority. At time t11, the processor 210 may execute the first process P1. At time t12, while the processor 210 is executing the first process P1, the second process P2 may be added to the waiting queue 232. Specifically, the synchronization manager 231 may determine whether the second process P2 accesses the shared resource SR. The synchronization manager 231 may add the second process P2 to the waiting queue 232 when the second process P2 performs an operation on the shared resource SR. Since the second process P2 is a process with high priority, the lock manager 233 may determine to deactivate the preemption. Since the preemptive scheduling is deactivated, the scheduler 234 may schedule processing of the processes to prioritize the execution of the first process P1. Accordingly, when the execution of the first process P1 on the shared resource SR is completed at time t13, the first process P1 may release the lock to the synchronization manager 231, and the lock manager 233 may control the scheduler 234 to perform the preemptive scheduling again in response to the release of the lock. The scheduler 234 may schedule the second process P2 to be executed by the processor 210 at time t12, and the execution of the second process P2 may be completed at time 113.

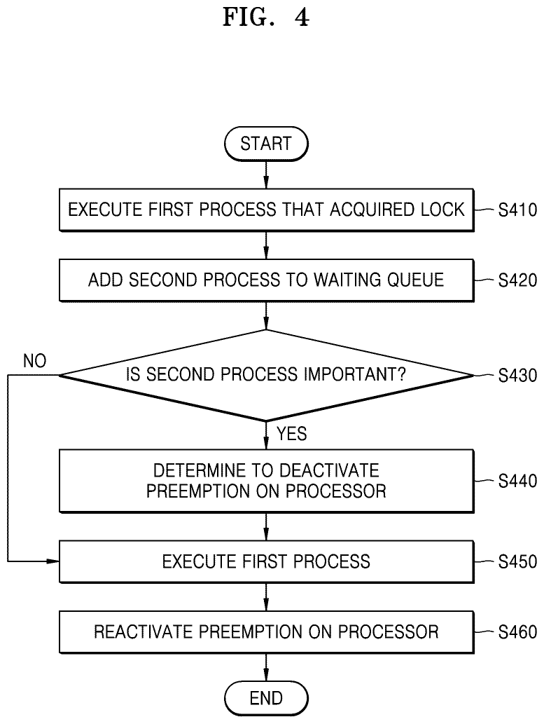

FIG. 4 is a flowchart illustrating a method of operating a system 10, according to one or more embodiments. Specifically, FIG. 4 is a flowchart illustrating a method of controlling access to a shared resource between processes. In an embodiment, the method of FIG. 4 may be performed when the lock control module LCM of FIG. 1 is executed by the processor 210. FIG. 4 may be described with reference to FIGS. 1 and 2, and duplicate descriptions may be omitted. The first process P1 and the second process P2 are processes including instructions for accessing the shared resource SR and processing information while being executed by the processor 210.

In operation 410, the processor 210 may execute the first process P1. The first process P1 may be a process that acquired a lock. The first process P1 may be a process that performs an operation on data included in the shared resource SR.

In an embodiment, the scheduler 234 may perform a scheduling operation such that the first process P1 loaded on memory may be executed by the processor 210. The synchronization manager 231 may grant the lock to the first process P1. The processor 210 may execute the first process P1 that acquired the lock.

In operation 420, the lock control module LCM may add the second process P2 to the waiting queue 232. The second process P2 may be a process that accesses the shared resource SR. In an embodiment, the lock control module LCM may add the second process P2 to the waiting queue 232 when the second process P2 performs an operation on the shared resource SR.

In an embodiment, the scheduler 234 may perform a scheduling operation such that the second process P2 loaded on memory may be executed by the processor 210. However, since the first process P1 that owns the lock is executed by the processor 210 as described above in operation 410, the synchronization manager 231 may not be executed until the first process P1 releases the lock. Thus, the synchronization manager 231 may cause the second process P2 to wait until the execution of the first process P1 on the shared resource SR is completed by adding the second process P2 to the waiting queue 232.

In operation 430, the lock control module LCM may check the priority of the second process P2. That is, the lock control module LCM may determine whether the second process P2 is a process with high priority. In other words, it may be determined whether the second process P2 is an important process.

In an embodiment, the second process P2 may be a process with high importance, which may mean that the second process P2 is a process with high priority. For example, when the contribution group to which the second process P2 belongs is a top-app group, the second process P2 may be a process with high importance. For example, when the second process P2 is a real-time process, the second process P2 may be classified as a process with high latency sensitivity, which may mean that the second process P2 is a process with high importance. For example, when the priority information of the second process P2 is higher than a priority reference value, the second process P2 may be a process with high importance.

In operation 440, the lock control module LCM may determine to deactivate the preemption for the processor 210 based on the priority of the second process P2 and the first process P1.

In an embodiment, when it is determined in operation 430 that the second process P2 is a process with high priority, the lock manager 233 may determine to deactivate the preemption for the processor 210. Specifically, the lock manager 233 may determine to deactivate the preemption for the processor 210 by controlling the scheduler 234 to schedule the deactivation of the preemption for the processor 210.

In an embodiment, when the contribution group to which the second process P2 belongs is a top-app group, the lock manager 233 may determine to deactivate the preemption.

In an embodiment, when the second process P2 is a real time process, the lock manager 233 may classify the second process P2 as a process with high latency sensitivity, and may determine to deactivate the preemption.

In an embodiment, when the priority information of the second process P2 is higher than the priority reference value, the lock manager 233 may determine to deactivate the preemption.

In operation 450, the processor 210 may execute the first process P1. In other words, the processor 210 may continue executing the first process P1 earlier than the second process P2, until the first process P1 releases the lock, to advance the time point at which the first process P1 releases the lock. In an embodiment, when it is determined to deactivate the preemption, context switching from the first process P1 to the second process P2 may not occur.

In operation 460, the lock control module LCM may reactivate the preemption for the processor 210. Specifically, when the execution of the first process P1 on the shared resource SR is completed in operation 450, the first process P1 may release the lock. That is, the lock control module LCM may retrieve the lock on the first process P1. In response to the first process P1 releasing the lock, the lock control module LCM may reactivate the preemption for the processor 210. The lock control module LCM may reactivate the preemption for the processor 210 and then execute the second process P2.

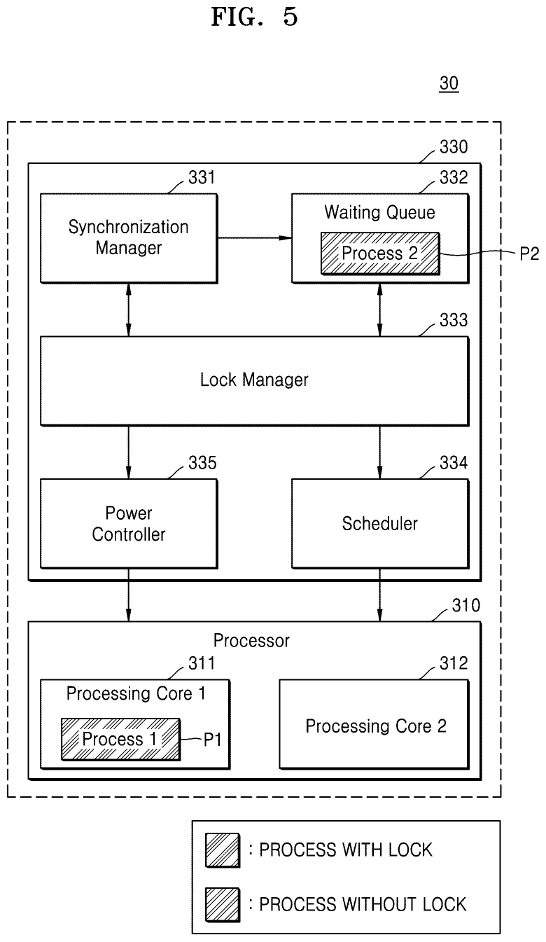

FIG. 5 is a block diagram of a system 30 according to one or more embodiments. Specifically, FIG. 5 is a diagram illustrating controlling the release of the lock of the lock owning process by controlling the processor 310 to operate in the first mode or the second mode. FIG. 5 may be described with reference to FIGS. 1 and 2, and duplicate descriptions may be omitted. In FIG. 5, the first process P1 and the second process P2 are processes including instructions for accessing the shared resource SR and processing information while being executed by the processor 310.

Referring to FIG. 5, the system 30 may include a processor 310, and a lock control module 330. The system 30 may correspond to the system 10 of FIG. 1. The system 30 of FIG. 5 may further include memory.

The processor 310 may correspond to the processor 110 of FIG. 1. In an embodiment, the processor 310 may include a first processing core 311 and a second processing core 312. Although only two processing cores are shown in the drawing, it is possible to include more processing cores. In an embodiment, the first processing core 311 may be a little core and the second processing core 312 may be a big core.

In an embodiment, the processor 310 may operate in a first mode or a second mode. The first mode may be referred to as a normal mode, and the second mode may be referred to as a high performance mode. When the processor 310 operates in the first mode, it may mean that it operates in a mode that provides relatively low performance and power consumption, and when the processor 310 operates in the second mode, it may mean that it operates in a mode that provides relatively high performance and power consumption. Accordingly, when the processor 310 operates in the second mode to execute a process, the process may be executed faster than when the processor 310 operates in the first mode to execute the process. In FIG. 5, the processor 310 operates in the first mode unless otherwise noted.

The lock control module 330 may include a synchronization manager 331, a waiting queue 332, a lock manager 333, a scheduler 334, and a power controller 335. In an embodiment, elements constituting the lock control module 330 may be implemented in software or hardware. The lock control module 330 may correspond to the lock control module LCM of FIG. 1. The synchronization manager 331 may correspond to the synchronization manager 231 of FIG. 2. The waiting queue 332 may correspond to the waiting queue 232 of FIG. 2.

When a new process is added to the waiting queue 332, the lock manager 333 may determine to cause the processor 310 to operate in the first mode or the second mode based on the priority of the added process.

The scheduler 334 may determine a process to be executed by the processor 310 and may allocate the determined process to the processing cores 311 and 312. The scheduler 334 may allocate a processing core to a process selected from the processes waiting in the waiting queue 332.

The power controller 335 may control the processor 310 to operate in the first mode or the second mode. The power controller 335 may operate under the control by the lock manager 333. In an embodiment, when the processor 310 operates in the first mode, it may mean that the processor 310 operates at a first clock frequency, and when the processor 310 operates in the second mode, it may mean that the processor 310 operates at a second clock frequency. The second clock frequency may be higher than the first clock frequency. In an embodiment, the power controller 335 may be referred to as a computing power controller.

In an embodiment, when the lock manager 333 determines to cause the processor 310 to operate in the first mode, the power controller 335 may set the clock frequency of the first processing core 311 or the second processing core 312 to be the first clock frequency. When the lock manager 333 determines to cause the processor 310 to operate in the second mode, the power controller 335 may set the clock frequency of the first processing core 311 or the second processing core 312 to be the second clock frequency.

In an embodiment, the second process P2 may be added to the waiting queue 332 while the processor 310 executes the first process P1 that owns the lock through the first processing core 311. The lock manager 333 may check the priority of the second process P2. When the second process P2 is a process with high priority, the lock manager 333 may determine to cause the processor 310 to operate in the second mode. That is, the lock manager 333 may control the processor 310 operating in the first mode to operate in the second mode through the power controller 335. The first processing core 311 may execute the first process P1 by operating at the second clock frequency. As such, the processor 310 may increase the computing power required to execute a process so that the first process P1 that owns the lock is executed more quickly. When the execution of the first process P1 on the shared resource SR is completed, the synchronization manager 331 may retrieve the lock from the first process P1. The lock manager 333 may determine to cause the processor 310 to operate in the first mode. That is, the lock manager 333 may control the processor 310 operating in the second mode to operate in the first mode again through the power controller 335.

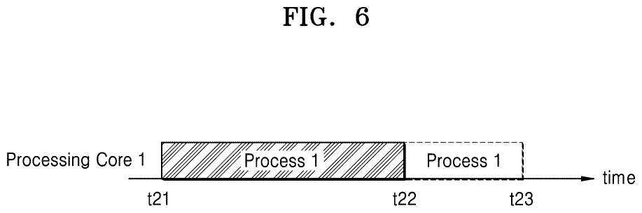

FIG. 6 is a diagram illustrating a lock release time point of a process in a system 30 according to one or more embodiments. FIG. 6 may be described with reference to FIGS. 1 and 5, and duplicate descriptions may be omitted. In FIG. 6, the first process P1 and the second process P2 are processes including instructions for accessing the shared resource SR and executing information while being executed by the processor 310.

In an embodiment, the second process P2 is a process with high priority. At time t21, the processor 310 may begin executing the first process P1 through the first processing core 311. The first processing core 311 is an example, and it is possible to begin executing the first process P1 through the second processing core 312. While the first processing core 311 is executing the first process P1, the second process P2 may be added to the waiting queue 332. Since the second process P2 is a process with high priority, the lock manager 333 may determine to cause the processor 310 to operate in the second mode. Thus, the lock manager 333 may control the processor 310 to operate in the second mode through the power controller 335, and the first processing core 311, which executed the first process P1 at the first clock frequency, may operate at the second clock frequency to thereby execute the first process P1. Accordingly, the time point at which execution of the first process P1 on the shared resource SR is completed is time t23 when the processor 310 operates in the first mode, while the time point at which execution of the first process P1 on the shared resource SR is completed is time t22 when the processor 310 operates in the second mode. Thus, by controlling the processor 310 to operate in the second mode, the lock release time point of the first process P1 may be advanced from time t23 to time t22.

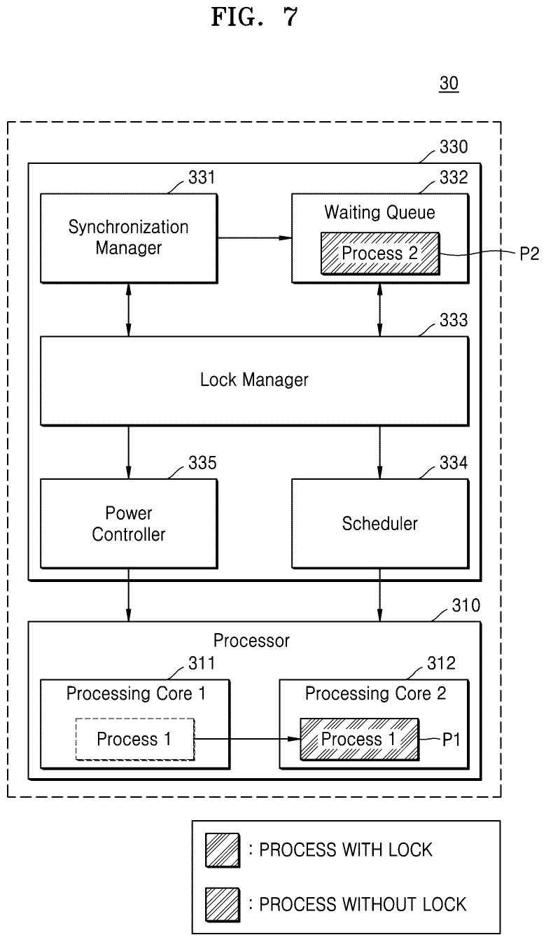

FIG. 7 is a block diagram of a system 30 according to one or more embodiments. Specifically, FIG. 7 is a diagram illustrating controlling the release of the lock of the lock owning process by controlling the processor 310 to operate in the first mode or the second mode. FIG. 7 may be described with reference to FIGS. 1, 2 and 5, and duplicate descriptions may be omitted. In FIG. 7, the first process P1 and the second process P2 are processes including instructions for accessing the shared resource SR and processing information while being executed by the processor 310. It is also assumed that the first processing core 311 is a little core and the second processing core 312 is a big core. In addition, in FIG. 7, the processor 310 operates in the first mode unless otherwise noted.

The power controller 335 may control the processor 310 to operate in the first mode or the second mode. The power controller 335 may operate under the control by the lock manager 333. In an embodiment, when the processor 310 operates in the first mode, it may mean that a process is executed through the little core. That is, the processor 310 may execute the process through the first processing core 311. When the processor 310 operates in the second mode, it may mean that a process is executed through the big core. That is, the processor 310 may execute the process through the second processing core 312.

In an embodiment, the second process P2 may be added to the waiting queue 332 while the processor 310 that operates in the first mode executes the first process P1 that owns the lock through the first processing core 311. The lock manager 333 may check the priority of the second process P2. When the second process P2 is a process with high priority, the lock manager 333 may determine to cause the processor 310 to operate in the second mode. That is, the lock manager 333 may control the processor 310 operating in the first mode to operate in the second mode through the power controller 335. The first process P1 may be migrated from the first processing core 311 to the second processing core 312 by the power controller 335. The processor 310 may execute the first process P1 through the second processing core 312. Since the second processing core 312 has higher performance than the first processing core 311, the second processing core 312 may execute operations related to the first process P1 more quickly. Accordingly, the time point at which the first process P1 releases the lock may be advanced. When the execution of the first process P1 on the shared resource SR is completed, the synchronization manager 331 may retrieve the lock from the first process P1. The lock manager 333 may determine to cause the processor 310 to operate in the first mode. That is, the lock manager 333 may control the processor 310 operating in the second mode to operate in the first mode again through the power controller 335. The scheduler 334 may schedule the second process P2 to be executed in the first processing core 311.

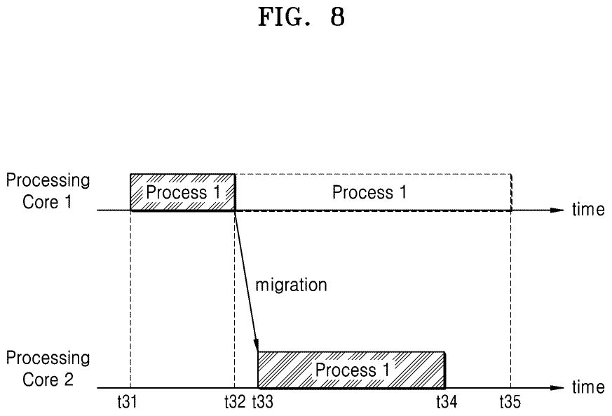

FIG. 8 is a diagram illustrating a lock release time point of a process in a system 30 according to one or more embodiments. FIG. 8 may be described with reference to FIGS. 1 and 7, and duplicate descriptions may be omitted. In FIG. 8, the first process P1 and the second process P2 are processes including instructions for accessing the shared resource SR and processing information while being executed by the processor 310.

In an embodiment, the second process P2 is a process with high priority. At time t31, the processor 310 may begin executing the first process P1 through the first processing core 311. While the first processing core 311 is executing the first process P1, the second process P2 may be added to the waiting queue 332. Since the second process P2 is a process with high priority, the lock manager 333 may determine to cause the processor 310 to operate in the second mode. Thus, the lock manager 333 may control the processor 310 to operate in the second mode through the power controller 335. At time t32, the power controller 335 may migrate the first process P1 to be executed in the second processing core 312. Accordingly, from time t33, the processor 310 may execute the first process P1 through the second processing core 312. Accordingly, the time point at which execution of the first process P1 on the shared resource SR is completed is time t35 when the processor 310 operates in the first mode, while the time point at which execution of the first process P1 on the shared resource SR is completed is time t34 when the processor 310 operates in the second mode. Thus, by controlling the processor 310 to operate in the second mode, the lock release time point of the first process P1 may be advanced from time t35 to time t34.

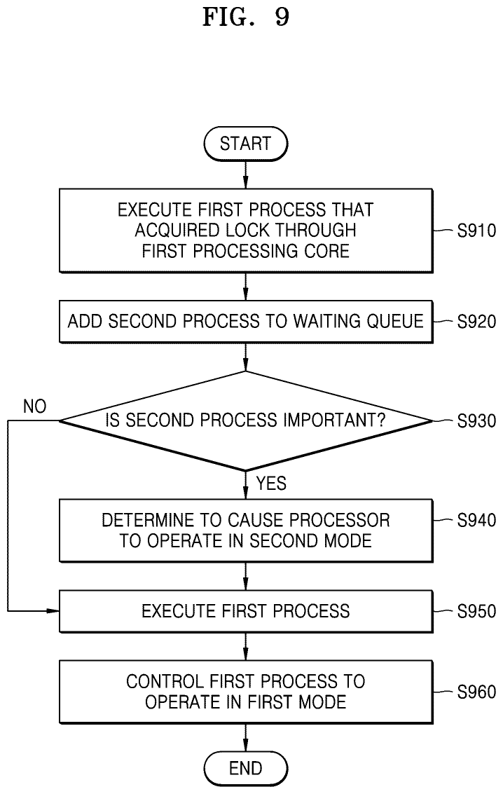

FIG. 9 is a flowchart illustrating a method of operating a system 30 according to one or more embodiments. Specifically, FIG. 9 is a flowchart illustrating a method of controlling access to a shared resource between processes. In an embodiment, the method of FIG. 9 may be performed when the lock control module LCM of FIG. 1 is executed by the processor 310. FIG. 9 may be described with reference to FIGS. 1, 5 and 7, and duplicate descriptions may be omitted, the first process P1 and the second process P2 are processes including instructions for accessing the shared resource SR and processing information while being executed by the processor 310.

In operation 910, the processor 310 may execute the first process P1 through the first processing core 311. The first process P1 may be a process that acquired a lock. The first process P1 may be a process that accesses the shared resource SR.

In an embodiment, the scheduler 334 may perform a scheduling operation such that the first process P1 loaded on memory may be executed by the processor 310. The synchronization manager 331 may grant the lock to the first process P1. The processor 310 may execute the first process P1 that acquired the lock.

In an embodiment, the processor 310 may operate in the first mode at stage 910. That is, the first process P1 may be executed by the first processing core 311, which is a little core. Alternatively, the first process P1 may be executed by the first processing core 311 operating at the first clock frequency.

In operation 920, the lock control module LCM may add the second process P2 to the waiting queue 332. The second process P2 may be a process that accesses the shared resource SR. In an embodiment, the lock control module LCM may add the second process P2 to the waiting queue 332 when the second process P2 performs an operation on the shared resource SR.

In an embodiment, the scheduler 334 may perform a scheduling operation such that the second process P2 loaded on memory may be executed by the processor 310. However, since the first process P1 that owns the lock is executed by the processor 310 as described above in operation 910, the second process P2 may not be executed until the first process P1 releases the lock. Thus, the synchronization manager 331 may cause the second process P2 to wait until the execution of the first process P1 on the shared resource SR is completed by adding the second process P2 to the waiting queue 332.

In operation 930, the lock control module LCM may check the priority of the second process P2. That is, the lock control module LCM may determine whether the second process P2 is a process with high priority. In other words, it may be determined whether the second process P2 is an important process.

In an embodiment, the second process P2 may be a process with high importance, which may mean that the second process P2 is a process with high priority. For example, when the contribution group to which the second process P2 belongs is a top-app group, the second process P2 may be a process with high importance. For example, when the second process P2 is a real-time process, the second process P2 may be classified as a process with high latency sensitivity, which may mean that the second process P2 is a process with high importance. For example, when the priority information of the second process P2 is higher than a priority reference value, the second process P2 may be a process with high importance.

In operation 940, the lock control module LCM may determine to cause the processor 310 to operate in the second mode based on the priorities of the second process P2 and the first process P1.

In an embodiment, when it is determined in operation 930 that the second process P2 is a process with high priority, the lock manager 333 may determine to cause the processor 310 to operate in the second mode. Specifically, the lock manager 333 may control the power controller 335 to control the processor 310 to operate in the second mode.

In an embodiment, when the contribution group to which the second process P2 belongs is a top-app group, the lock manager 333 may determine to cause the processor 310 to operate in the second mode.

In an embodiment, when the second process P2 is a real time process, the lock manager 333 may classify the second process P2 as a process with high latency sensitivity, and the lock manager 333 may determine to cause the processor 310 to operate in the second mode.

In an embodiment, when the priority information of the second process P2 is higher than the priority reference value, the lock manager 333 may determine to cause the processor 310 to operate in the second mode. In operation 950, the processor 310 may execute the first process P1. In other words, the processor 310 may continue executing the first process P1 earlier than the second process P2 until the first process P1 releases the lock, to advance the time point at which the first process P1 releases the lock. In an embodiment, the processor 310 may execute the first process P1 through the first processing core 311 operating at the second clock frequency. In an embodiment, the processor 310 may execute the first process P1 through the second processing core 312.

In operation 960, the lock control module LCM may control the processor 310 to operate in the first mode. Specifically, when the execution of the first process P1 on the shared resource SR is completed in operation 950, the lock control module LCM may retrieve the lock on the first process P1. In response to the release of the lock by the first process P1, the lock control module LCM may determine to cause the processor 310 to operate in the first mode. The processor 310 operating in the first mode may execute the second process P2 through the first processing core 311.

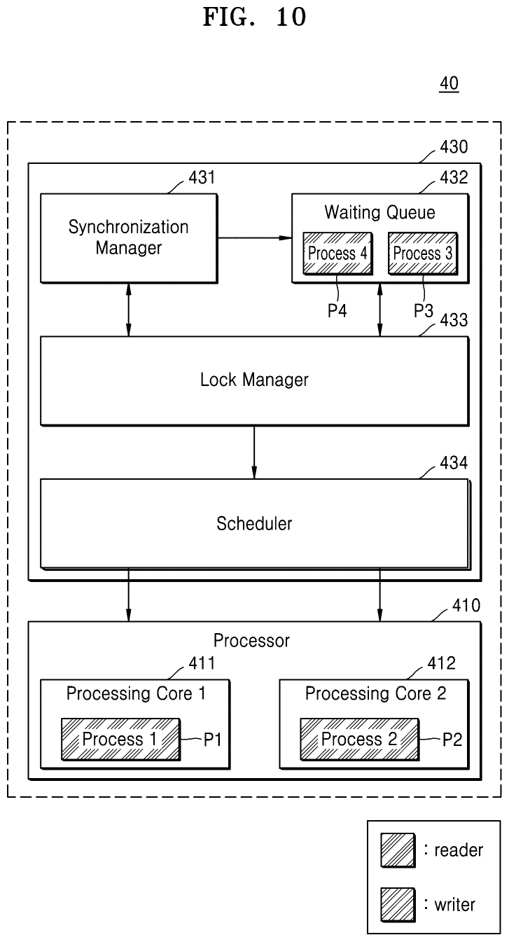

FIG. 10 is a block diagram of a system 40 according to one or more embodiments. Specifically, FIG. 10 is a diagram illustrating controlling the release of the lock of the lock owning process by extending a read phase. FIG. 10 may be described with reference to FIGS. 1, 2, 5 and 7, and duplicate descriptions may be omitted. In FIG. 10, the first process P1 to the fourth process P4 are processes including instructions for accessing the shared resource SR and processing information while being executed by the processor 410. In FIG. 10, a process that performs a read operation on the shared resource SR may be referred to as a read process or a reader, and a process that performs a write operation may be referred to as a write process or a writer.

Referring to FIG. 10, the system 40 may include a processor 410 and a lock control module 430. The system 40 may correspond to the system 10 of FIG. 1. The system 40 of FIG. 10 may further include memory.

The processor 410 may correspond to the processor 110 of FIG. 1. The processor 410 may include a first processing core 411 and a second processing core 412. The lock control module 430 may include a synchronization manager 431, a waiting queue 432, a lock manager 433, and a scheduler 434.

In an embodiment, elements constituting the lock control module 430 may be implemented in software or hardware. The lock control module 430 may correspond to the lock control module LCM of FIG. 1. The waiting queue 432 may correspond to the waiting queue 432 of FIG. 2.

When there are two or more processes that need to perform an operation on the shared resource SR, the synchronization manager 431 may manage the shared resource SR to be synchronized based on whether the processes perform a read operation or a write operation on the shared resource SR. The lock granted to a process by the synchronization manager 431 may be a read lock or a write lock. For example, the synchronization manager 231 may grant a read lock to processes performing a read operation on the shared resource SR, and may retrieve the read lock. For example, the synchronization manager 231 may grant a read lock to processes performing a write operation on the shared resource SR, and may retrieve the write lock.

In an embodiment, the read lock may be granted to at least one process performing a read operation on the shared resource SR executed on the processor 410. In other words, the read lock may be owned by several processes simultaneously. The write lock may be granted only to one process that performs a write operation on the shared resource SR executed on the processor 410. Thus, unlike the read lock, the write lock may be owned by only one process.

In an embodiment, when the process performing the read operation on the shared resource SR owns the read lock, other processes that need to perform the read operation on the shared resource SR afterwards may immediately acquire the read lock without waiting in the waiting queue 432. The synchronization manager 431 may set the read phase under the control by the lock manager 433. When the read phase is set, a continuous read operation on the shared resource SR may be allowed.

In an embodiment, when the process performing the write operation on the shared resource SR owns the write lock, other processes that need to perform the read operation or the write operation on the shared resource SR may wait in the waiting queue 432 until the corresponding process completes the write operation on the shared resource SR.

When a new process is added to the waiting queue 432, the lock manager 433 may determine to extend the read phase based on the priority of the added process. During the time period set as the read phase, processes that need to perform a write operation may wait in the waiting queue 432 without being executed by the processor 410.

The scheduler 434 may determine a process to be executed by the processor 410, and may assign the determined process to the processor 410. In addition, the scheduler 434 may operate under the control by the lock manager 433 to assign processes to the processor 410 based on the priority of the processes.

In an embodiment, the processes executed by the processor 410 may be read processes that perform a read operation or write processes that perform a write operation. The first process P1, the second process P2, and the fourth process P4 are read processes. The third process P3 is a writing process. The processor 410 may execute the first process P1 to the fourth process P4. The processor 410 may execute a read operation on the first process P1 through the first processing core 411. The first process P1 may be a process that acquired a read lock. The processor 410 may execute a read operation on the second process P2 through the second processing core 412. The second process P2 may be a process that acquired a read lock. The third process P3 and the fourth process P4 may be added to the waiting queue 432 while the processor 410 is executing the first process P1 and the second process P2. The lock manager 433 may determine whether to extend the read phase based on the priorities of the third process P3 and the fourth process P4 added to the waiting queue 432.

In an embodiment, the lock manager 433 may determine to extend the read phase when the priority of the fourth process P4 is higher than that of the third process P3. In an embodiment, when the fourth process P4 is a process with high priority, the lock manager 433 may determine to extend the read phase.

The synchronization manager 431 may extend the read phase under the control by the lock manager 433, and may prioritize the read operation on the fourth process P4 over the write operation on the third process P3. That is, although the third process P3 is added to the waiting queue 432 prior to the fourth process P4, the synchronization manager 431 may prioritize the read operation of the fourth process P4. The first process P1, the second process P2, and the fourth process P4 may each release a read lock to the synchronization manager 431 when the read operation on the shared resource SR is completed.

When the read operation of the fourth process P4 on the shared resource SR corresponding to the last read operation of the read phase is completed, the fourth process P4 may release the read lock to the synchronization manager 431. When all read locks have been released, the lock manager 433 may determine to terminate the read phase. In an embodiment, when the read phase is terminated, it may mean that the extension of the read phase is terminated. Since all read locks have been released, the synchronization manager 431 may terminate the read phase under the control by the lock manager 433. Accordingly, the scheduler 434 may schedule the write operation of the third process P3 waiting in the waiting queue 432 to be executed by the processor 410.

As described above, according to one or more embodiments, performance of the read operation may be improved by preferentially executing a process that needs to perform the read operation based on the priority of the process.

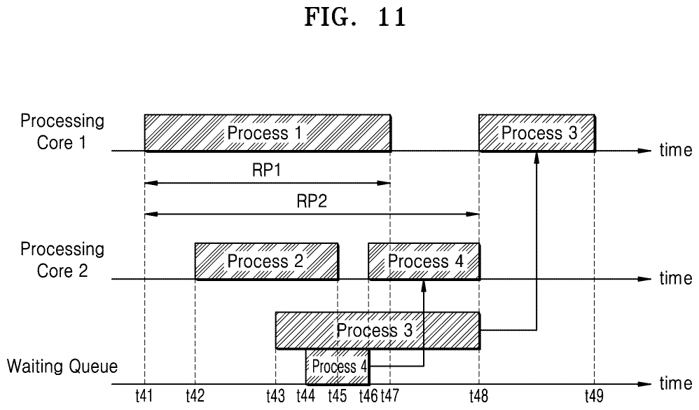

FIG. 11 is a diagram illustrating a lock release time point of a process in a system 40 according to one or more embodiments. FIG. 11 may be described with reference to FIGS. 1 and 10, and duplicate descriptions may be omitted. In FIG. 11, the first process P1 to the fourth process P4 are processes including instructions for accessing the shared resource SR and processing information while being executed by the processor 410.

In an embodiment, the priority of the fourth process P4 is higher than that of the third process P3. At time t41, the processor 410 may begin executing the read operation of the first process P1 through the first processing core 411. At time t42, the processor 410 may begin executing the read operation of the second process P2 through the second processing core 412. Since the first process P1 and the second process P2 are processes that perform a read operation on the shared resource SR, they may own the read lock. Since a continuous read operation on the shared resource SR is performed, the synchronization manager 431 may set a first read phase RP1. The first read phase RP1 may refer to a time period from time t41 to time t47.

While the first processing core 411 and the second processing core 412 are executing the read operation of the first process P1 and the read operation of the second process P2, the write operation of the third process P3 may be added to the waiting queue 432 at time t43. Since the third process P3 is a process that performs the write operation on the shared resource SR, the third process P3 may wait in the waiting queue 432 until the first process P1 and the second process P2 release the read lock. In other words, the write operation on the third process P3 may wait in the waiting queue 432 until the first read phase RP1 ends.

At time t44, the read operation of the fourth process P4 may be added to the waiting queue 432. The fourth process P4 is a process that performs the read operation on the shared resource SR, but the read operation of the fourth process P4 may be added to the waiting queue 432 since the write operation of the third process P3 is waiting in the waiting queue 432. The lock manager 433 may check the priorities of the write operation of the third process P3 and the read operation of the fourth process P4. The lock manager 433 may determine to extend the read phase based on the priorities of the third process P3 and the fourth process P4. For example, the lock manager 433 may determine to extend the read phase because the priority of the read operation of the fourth process P4 is higher than that of the write operation of the third process P3. In addition, for example, the lock manager 433 may determine to extend the read phase since the fourth process P4 is a process with high priority. The synchronization manager 431 may extend the read phase from the first read phase RP1 to the second read phase PR2 under the control by the lock manager 431. The second read phase RP2 may refer to a time period from time t41 to time t48.

At time t45, the read operation of the second process P2 on the shared resource SR may be completed, so that the second process P2 may release the read lock to the synchronization manager 431. At time t46, the second processing core 412 may execute the fourth process P4.

At time t47, the read operation of the first process P1 on the shared resource SR may be completed, so that the first process P1 may release the read lock to the synchronization manager 431. At time t48, the read operation of the fourth process P4 on the shared resource SR may be completed, so that the fourth process P4 may release the read lock to the synchronization manager 431. Since all read locks have been released from processes that own the read lock, the lock manager 431 may terminate the extension of the read phase. Since the read phase has been terminated, the write operation of the third process P3 may be executed by the first processing core 411. The third process P3 may acquire the write lock from the synchronization manager 431. At time t49, the write operation of the third process P3 on the shared resource SR may be completed, and the third process P3 may release the write lock to the synchronization manager 431.

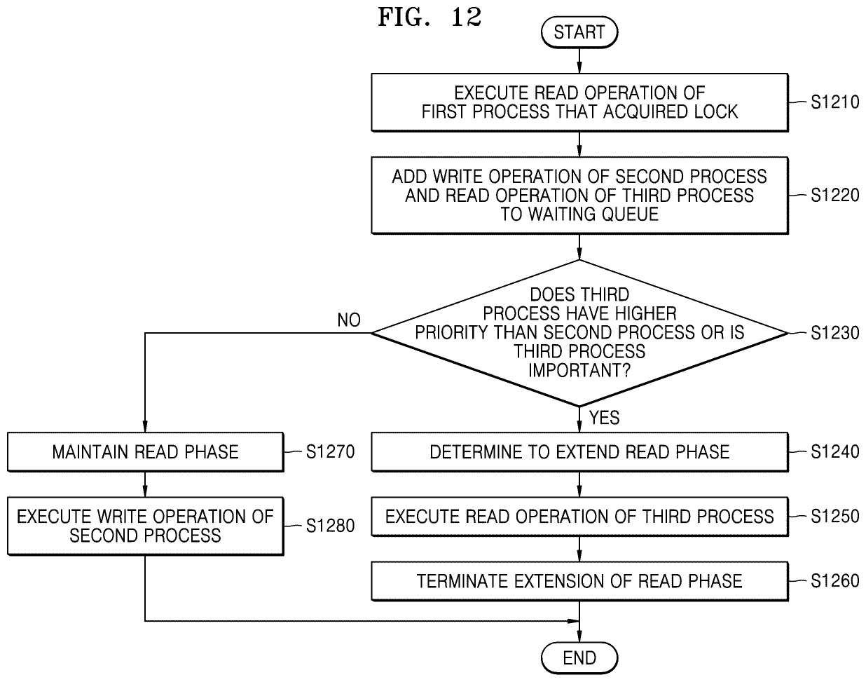

FIG. 12 is a flowchart illustrating a method of operating a system 40 according to one or more embodiments. Specifically, FIG. 12 is a flowchart illustrating a method of controlling access to a shared resource between processes. In an embodiment, the method of FIG. 12 may be performed when the lock control module LCM of FIG. 1 is executed by the processor 410. FIG. 12 may be described with reference to FIGS. 1 and 10, and duplicate descriptions may be omitted.

In FIG. 12, for convenience of description, the processor 410 executes the first process P1 to the third process P3, unlike in FIG. 10 which illustrates four processes, the first process P1 and the third process P3 are processes that access the shared resource SR and perform the read operation, the second process P2 is a process that accesses the shared resource SR and performs the write operation.

In operation 1210, the processor 410 may execute the read operation of the first process P1. The first process P1 may be a process that acquired a read lock. The first process P1 may be a process that performs a read operation on data included in the shared resource SR.

In an embodiment, the scheduler 434 may perform a scheduling operation such that the first process P1 loaded on memory may be executed by the processor 410. The synchronization manager 431 may grant the read lock to the first process P1. The processor 410 may execute, through the processor 410, the read operation of the first process P1 that acquired the lock.

In operation 1220, the lock control module LCM may add a write operation of the second process P2 to the waiting queue 432 and a read operation of the third process P3 to the waiting queue 432, the write operation of the second process P2 is added to the waiting queue 432 prior to the read operation of the third process P3. The second process P2 may be a process that performs a write operation on data included in the shared resource SR. The third process P3 may be a process that performs a read operation on data included in the shared resource SR.

In an embodiment, the scheduler 434 may perform a scheduling operation such that the second process P2 and the third process P3 which are loaded on memory may be executed by the processor 410. However, since the read operation of the first process P1 that owns the read lock is being executed through the processor 410 as described above in operation 1210, the write operation of the second process P2 may not be executed until the first process P1 releases the lock. Thus, the synchronization manager 431 may cause the second process P2 to wait until the operation of the first process P1 on the shared resource SR is completed by adding the write operation of the second process P2 to the waiting queue 232. Since the read operation of the third process P3 is added to the waiting queue 432 after the write operation of the second process P2, it can wait in the waiting queue 432.

In operation 1230, the lock control module LCM may check the priorities of the second process P2 and the third process P3. Specifically, the lock control module LCM may check whether the priority of the third process P3 is higher than that of the second process P2, or whether the third process P3 is an important process (i.e., whether the third process P3 is a process with high priority). In an embodiment, the lock control module LCM may compare the priority of the second process P2 with the priority of the third process P3. For example, the third process P3 may be more important than the second process P2, which means that the priority of the third process P3 is higher than that of the second process P2. In an embodiment, the lock control module LCM may check whether the third process P3 is a process with high priority. For example, when the contribution group to which the third process P3 belongs is a top-app group, the third process P3 may be a process with high importance. For example, when the third process P3 is a real-time process, the third process P3 may be classified as a process with high latency sensitivity, which may mean that the third process P3 is a process with high importance. For example, when the priority information of the third process P3 is higher than a priority reference value, the third process P3 may be a process with high importance.

In operation 1240, the lock control module LCM may determine to extend the read phase, based on the priority of the write operation of the second process P2 and the priority of the read operation of the third process P3.

In an embodiment, when it is determined in operation 1230 that the priority of the third process P3 is higher than that of the second process P2 (i.e., when the priority of the second process P2 is lower than that of the third process P3), the lock manager 433 may determine to extend the read phase. Specifically, the lock manager 433 may cause the read phase to extend through the synchronization manager 431.

In an embodiment, when the contribution group to which the third process P3 belongs is a top-app group, the lock manager 433 may determine to extend the read phase.

In an embodiment, when the third process P3 is a real time process, the lock manager 333 may classify the third process P3 as a process with high latency sensitivity, and the lock manager 433 may determine to extend the read phase.

In an embodiment, when the priority information of the third process P3 is higher than the priority reference value, the lock manager 433 may determine to extend the read phase. In operation 1250, the processor 410 may execute the read operation of the third process P3. In an embodiment, when the read operation of the first process P1 on the shared resource SR is not completed, the processor 410 may also execute the read operation of the first process P1. In other words, the read operation of the first process P1 and the read operation of the third process P3 may be performed in parallel. By extending the read phase until the first process P1 and the third process P3 release the read lock, the processes that perform the read operation may be preferentially executed.

In operation 1260, the lock control module LCM may terminate the extension of the read phase. In an embodiment, the first process P1 may release the read lock to the synchronization manager 433 when execution of the read operation of the first process P1 on the shared resource SR is completed. When the execution of the read operation of the third process P3 on the shared resource SR is completed, the third process P3 may release the read lock to the synchronization manager 433. In response to the release of all read locks on the shared resource SR to the synchronization manager 431, the lock manager 433 may determine to terminate the extension of the read phase. The lock manager 433 may terminate the extension of the read phase through the synchronization manager 431. After the extension of the read phase is terminated, the write operation of the second process P2 may be executed by the processor 410.

In operation 1270, the lock control module LCM may maintain the read phase based on the priority of the second process P2 and the priority the third process P3. In other words, it may be determined not to extend the read phase.

In an embodiment, when it is determined in operation 1230 that the priority of the third process P3 is lower than that of the second process P2 (i.e., when the priority of the second process P2 is higher than that of the third process P3), the lock manager 433 may determine to maintain the read phase. In other words, it may be determined not to extend the read phase.

In an embodiment, when it is determined in operation 1230 that the third process P3 is not a process with high importance, the lock manager 433 may determine to maintain the read phase. In other words, it may be determined not to extend the read phase.

In operation 1280, the processor 410 may execute the write operation of the second process P2. In an embodiment, the first process P1 may release the read lock to the synchronization manager 431 when execution of the read operation of the first process P1 on the shared resource SR is completed. Since all read locks have been released and the read phase has not been extended, the write operation of the second process P2 may be executed earlier than the read operation of third process P3. The second process P2 may obtain the write lock from the synchronization manager 431, and when execution of the write operation of the second process P2 on the shared resource SR is completed, the second process P2 may release the write lock to the synchronization manager 431. After the second process P2 releases the write lock, the read operation of the third process P3 may be performed.

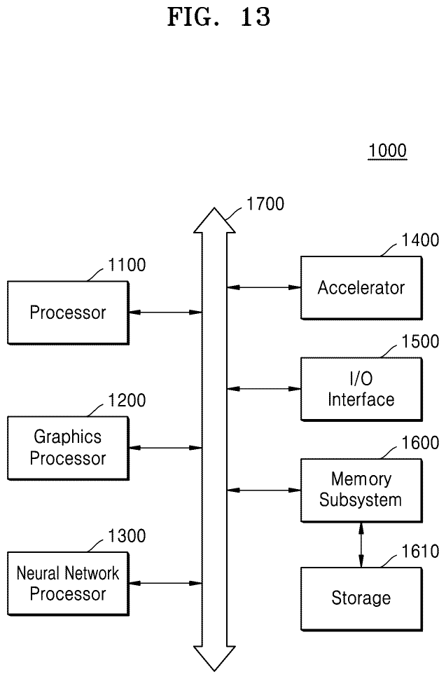

FIG. 13 is a block diagram of a system 1000 according to one or more embodiments. Specifically, the system 1000 of FIG. 13 may correspond to the systems according to some embodiments of FIGS. 1-12. FIG. 13 may be described with reference to FIG. 1, and duplicate descriptions may be omitted.

As shown in FIG. 13, the system 1000 may include a processor 1100, a graphics processor 1200, a neural network processor 1300, an accelerator 1400, an I/O interface 1500, a memory subsystem 1600, storage 1610, and a bus 1700. The processor 1100, the graphics processor 1200, the neural network processor 1300, the accelerator 1400, the I/O interface 1500, and the memory subsystem 1600 may communicate with each other through the bus 1700. In an embodiment, the system 1000 may be a system-on-chip (SoC) in which components are implemented on one chip, and the storage 1610 may be external to the system-on-chip. In an embodiment, at least one of the components shown in FIG. 13 may be omitted from the system 1000.

The processor 1100 may control the operation of the system 1000 at the highest layer, and may control other components of the system 1000. The processor 1100 may communicate with the memory subsystem 1600, and may execute instructions. In an embodiment, the processor 1100 may execute a program stored in the memory subsystem 1600. The program may include a series of instructions. The processor 1100 may be any hardware capable of independently executing instructions and may be referred to as an application processor (AP), a communication processor (CP), a CPU, a processor core, a core, and the like.

The graphics processor 1200 may execute instructions related to graphics processing, and may provide data generated by processing data acquired from the memory subsystem 1600 to the memory subsystem 1600.

The neural network processor 1300 may be designed to quickly process operations based on artificial neural networks, and may enable functions based on artificial intelligence (AI).

In an embodiment, the processor 1100, the graphics processor 1200, and the neural network processor 1300 may include two or more processing cores. As described above with reference to the drawings, the processor 1100 may execute a method of controlling access to the shared resource according to the present disclosure.

The accelerator 1400 may be designed to perform specified functions at high speeds. For example, the accelerator 1400 may provide data generated by processing data acquired from the memory subsystem 1600 to the memory subsystem 1600.

The I/O interface 1500 may provide an interface for acquiring an input from the outside of the system 1000 and providing an output to the outside of the system 1000.

The memory subsystem 1600 may be accessed by other components connected to the bus 1700. In an embodiment, the memory subsystem 1600 may include volatile memory, such as DRAM, SRAM, and may include non-volatile memory such as flash memory, resistive random access memory (RRAM). In addition, in an embodiment, the memory subsystem 1600 may provide an interface to the storage 1610. The storage 1610 may be a storage medium that does not lose data even when power is shut off. For example, the storage 1610 may include a semiconductor memory device, such as non-volatile memory, and may include any storage medium, such a magnetic card/disk or optical card/disk. A method of controlling access to the shared resource between processes according to one or more embodiments may be stored in the memory subsystem 1600 or the storage 1610.

The memory subsystem 1600 may be accessed by the processor 1100, and may store a software element executable by the processor 1100. The software element may include, but is not limited to, a software component, a program, an application, a computer program, an application program, a system program, a software development program, a machine program, OS software, middleware, firmware, a software module, a routine, a subroutine, a function, a method, a procedure, a software interface, an API, an instruction set, computing code, computer code, a code segment, a computer cord segment, a word, a value, a symbol, or a combination of two or more thereof.

The bus 1700 may operate based on one of various bus protocols. The various bus protocols may include at least one of advanced microcontroller bus architecture (AMBA) protocol, universal serial bus (USB) protocol, multimedia card (MMC) protocol, peripheral component interconnect (PCI) protocol, PCI-express (PCI-E) protocol, advanced technology attachment (ATA) protocol, serial-ATA protocol, parallel-ATA protocol, small computer small interface (SCSI) protocol, enhanced small disk interface (ESDI) protocol, integrated drive electronics (IDE) protocol, mobile industry processor interface (MIPI) protocol, universal flash storage (UFS) protocol, and the like.

While example embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims and their equivalents. Also, it is intended that such modifications are not to be interpreted independently from the technical idea or prospect of the disclosure.

1. A method of controlling access to shared resources, comprising:
executing, by a processor, a first process that acquires a lock on a shared resource;
adding a second process to a waiting queue;
determining whether to deactivate preemption for the processor based on a priority of the second process;
based on determining to deactivate preemption for the processor, executing, by the processor, the first process until execution of the first process on the shared resource is completed;
retrieving the lock from the first process after execution of the first process on the shared resource is completed; and
reactivating preemption for the processor.

2. The method of claim 1, wherein the priority of the second process is determined based on at least one of a contribution group to which the second process belongs, a latency sensitivity of the second process, and priority information set when the second process is created.

3. The method of claim 2, wherein the determining whether to deactivate preemption for the processor comprises:
determining to deactivate preemption for the processor based on at least one of determining that the contribution group to which the second process belongs is a top-app group, determining that the second process is a real-time process having high latency sensitivity, and determining that the priority information is higher than a reference value.

4. The method of claim 1, wherein context switching from the first process to the second process is prevented by deactivating preemption for the processor.

5. The method of claim 1, wherein the adding the second process to the waiting queue comprises:
adding the second process to the waiting queue based on the second process performing an operation on the shared resource.

6. The method of claim 1, further comprising:
executing, by the processor, the second process after reactivating preemption for the processor.

7. A method of controlling access to shared resources, comprising:
executing, by a processor operating in a first mode, a first process that acquires a lock on a shared resource;
adding a second process to a waiting queue;
controlling the processor to operate in a second mode based on a priority of the second process;
executing the first process, by the processor operating in the second mode, until execution of the first process on the shared resource is completed;
retrieving the lock from the first process after execution of the first process on the shared resource is completed; and
controlling the processor to operate in the first mode.

8. The method of claim 7, wherein the priority of the second process is determined based on at least one of a contribution group to which the second process belongs, a latency sensitivity of the second process, and priority information set when the second process is created.

9. The method of claim 8, wherein the controlling the processor to operate in the second mode comprises:
controlling the processor to operate in the second mode based on at least one of determining that the contribution group to which the second process belongs is a top-app group, determining that the second process is a real-time process having high latency sensitivity, and determining that the priority information is higher than a reference value.

10. The method of claim 9, wherein the processor is a heterogeneous multi-core processor comprising at least a first processing core and a second processing core, and
wherein the first processing core is a little core and the second processing core is a big core.

11. The method of claim 10, wherein the executing the first process, by the processor operating in the second mode, comprises:
migrating the first process from the first processing core to the second processing core.

12. The method of claim 10, further comprising:
based on controlling the processor to operate in the first mode, executing the second process through the first processing core.

13. The method of claim 9, further comprising:
setting a clock frequency of the processor to a first clock frequency based on the processor operating in the first mode; and
setting a clock frequency of the processor to a second clock frequency based on the processor operating in the second mode,
wherein the second clock frequency is higher than the first clock frequency.

14. The method of claim 7, wherein the adding the second process to the waiting queue comprises:
adding the second process to the waiting queue based on the second process performing an operation on the shared resource.

15. A method of controlling access to shared resources, comprising:
executing, by a processor, a read operation of a first process that acquires a lock on a shared resource during a read phase, the read operation corresponding to the shared resource;
adding a write operation of a second process and a read operation of a third process to a waiting queue, the write operation of the second process and the read operation of the third process corresponding to the shared resource;
determining whether to extend the read phase based on a priority of the third process and a priority of the second process;
based on determining to extend the read phase, executing, by the processor, the read operation of the third process; and
terminating the read phase.

16. The method of claim 15, wherein the lock comprises a read lock or a write lock, and further comprising:
granting the read lock to at least one process to perform a read operation on the shared resource; and
granting the write lock to only one process to perform a write operation on the shared resource.

17. The method of claim 16, wherein granting the read lock to the at least one process comprises: granting the read lock to the first process based on executing the read operation of the first process: and granting the read lock to the third process when the read operation of the third process is executed,
wherein granting the write lock to only the one process comprises granting the write lock to the second process based on executing the write operation of the second process.

18. The method of claim 16, wherein the determining whether to extend the read phase comprises determining to extend the read phase based on the priority of the second process being lower than the priority of the third process, and
wherein the executing the read operation of the third process comprises executing the read operation of the third process in parallel with the read operation of the first process.

19. The method of claim 16, wherein the priority of the second process or the priority of the third process is determined based on at least one of a contribution group to which the second process or the third process belong, a latency sensitivity of the second process or the third process, and priority information set when the second process or the third process is created, respectively.

20. The method of claim 19, wherein the determining whether to extend the read phase comprises:
determining to extend the read phase based on at least one of determining that the contribution group to which the third process belongs is a top-app group, determining that the third process is a real-time process having high latency sensitivity, and determining that the priority information is higher than a reference value.

21-40. (canceled)
